(19) United States
(12) Patent Application Publication
(10) Pub. No.: US 2019/0217783 A1
(43) Pub. Date: Jul. 18, 2019

(54) ELECTRON MIRROR APPARATUS

(71) Applicant: Panasonic Intellectual Property Management Co., Ltd.., Osaka (JP)

(72) Inventors: Yusuke HASEGAWA, Kanagawa (JP); Yuji MATSUMOTO, Kanagawa (JP)

(21) Appl. No.: 16/307,010

(22) PCT Filed: Jul. 4, 2017
(86) PCT No.: PCT/JP2017/024474

§ 371 Date: Dec. 4, 2018

(30) Foreign Application Priority Data
Jul. 6, 2016 (JP) 2016-134232
Dec. 28, 2016 (JP) 2016-255158

(51) Int. Cl. B60R 1/12; B60R 1/04; B60R 1/08; B60R 11/04; H04N 5/232; H04N 7/18

(52) U.S. Cl. CPC B60R 1/12; B60R 1/04; B60R 1/088; B60R 1/087; B60R 11/04; H04N 5/23203; B60R 2001/1215; B60K 2370/152; B60K 2370/21; B60K 2370/27; B60K 2370/37; B60K 2370/52; H04N 7/183

(57) ABSTRACT

A rear view mirror assembly can switch the operating mode between a first mode in which the rear view mirror assembly is used as an optical mirror, a second mode in which a first image captured by a camera is displayed on a display screen, and a third mode in which a second image captured by the camera and displayed darker than the first image is displayed on the display screen. An actuator sets the angle of a semitransparent mirror: at a first angle in the first mode; at a second angle greater than the first angle in the second mode; and at a third angle greater than the first angle in the third mode. A controller switches the operating mode of the rear view mirror assembly between the first mode and the third mode based on a signal output from a first light sensor and indicating the illuminance.

### TECHNICAL FIELD

The present disclosure relates to a rear view mirror assembly.

### BACKGROUND ART

Conventionally, a rearview mirror has been used as an apparatus for checking rearward of a vehicle, such as an automobile, during driving of the vehicle. The rearward is checked using the reflected image in an optical mirror. In recent years, as a substitute apparatus for such a rearview mirror, a rear view mirror assembly has been devised. The rear view mirror assembly allows the driver to check an image, captured by a camera mounted in a rear part of the vehicle, on a monitor mounted in front of the driver.

Examples of such a rear view mirror assembly include a rearview mirror having a built-in monitor (see Patent Literature (PTL) 1). FIG. 16 illustrates a configuration of the rearview mirror having the built-in monitor disclosed in PTL 1. In the rearview mirror having the built-in monitor illustrated in FIG. 16, mirror 4 is fit in rearview mirror body 1, and liquid crystal display monitor 5 is built in to a part of mirror 4. Monitor 5 can display an image captured by a camera externally mounted on the vehicle. In a state where monitor 5 is off, mirror 4 is set at a usual operation angle at which a driver can view an image of the rear windshield, and by using mirror 4, the driver can check rearward through the rear windshield. When monitor 5 is turned on, a signal is transmitted to drive unit 7. The signal causes drive unit 7 to turn rearview mirror body 1 to be at a glare-avoiding angle. With this turn, a dark portion other than the rear windshield comes to be reflected in monitor 5 or mirror 4 surrounding monitor 5 when viewed from the driver. This allows the driver to view an image and the like being displayed on monitor 5, without being dazzled.

However, in cases where the vehicle is travelling in a dark ambient environment, such as at nighttime or in a tunnel, and intense light coming from headlights and the like of a following vehicle is reflected in the rearview mirror, an occupant (for example, the driver) sometimes suffers from glare of the light, in viewing the rearview mirror. Rearview mirror 1 having the built-in monitor disclosed in PTL 1 has a problem that the driver suffers from glare when the driver is checking rearward while viewing the entirety of mirror 4.

One of means to solve such a problem is an electrochromic mirror (see PTL 2). The electrochromic mirror disclosed in PTL 2 employs electrochromic device 18 with the mirror part having variable reflectivity as illustrated in FIG. 17, instead of a usual optical mirror. The reflectivity of electrochromic device 18 is varied in response to the intensity of light coming from rearward of the vehicle, thereby reducing glare of the light coming from rearward of the vehicle. Such a function of reducing the glare from which an occupant suffers in viewing the mirror, as described above, is referred to as an antiglare function. Electrochromic device 18 electrically provides an antiglare function to an occupant.

### CITATION LIST

### Patent Literature

PTL 1: Japanese Unexamined Patent Application Publication No. 2002-120649

PTL 2: U.S. Patent Application Publication No. 2004/0047043

### SUMMARY OF THE INVENTION

The present disclosure provides a rear view mirror assembly having an enhanced antiglare function without using an electrochromic reflective element.

A rear view mirror assembly according to the present disclosure includes a display, a semitransparent mirror, an actuator, a controller, and a first light sensor. The display includes a display screen which displays a rearward image of a vehicle. The image is captured by a camera mounted to the vehicle. The semitransparent mirror is disposed over the display screen. The actuator tilts the semitransparent mirror. The controller drives the actuator. The first light sensor outputs a signal indicating the illuminance of light emitted from rearward of the vehicle. The operating mode of the rear view mirror assembly is switchable between a first mode, a second mode, and a third mode. In the first mode, the rear view mirror assembly is used as an optical mirror. In the second mode, a first image captured by the camera is displayed on the display screen. In the third mode, a second image, which is captured by the camera and which is displayed darker than the first image, is displayed on the display screen. The actuator sets the semitransparent mirror in the first mode such that a vertical upward vector and a surface of the semitransparent mirror form a first angle. The actuator sets the semitransparent mirror in the second mode such that the vertical upward vector and the surface of the semitransparent mirror form a second angle greater than the first angle. The actuator sets the semitransparent mirror in the third mode such that the vertical upward vector and the surface of the semitransparent mirror form a third angle greater than the first angle. The controller switches the operating mode of the rear view mirror assembly between the first mode and the third mode, based on the signal output from the first light sensor.

The present disclosure can provide a rear view mirror assembly having an enhanced antiglare function without using an electrochromic reflective element.

### BRIEF DESCRIPTION OF DRAWINGS

FIG. 1 illustrates a vehicle equipped with a rear view mirror assembly according to a first exemplary embodiment.

FIG. 2 is a cross-sectional view of the rear view mirror assembly according to the first exemplary embodiment.

FIG. 3 is another cross-sectional view of the rear view mirror assembly according to the first exemplary embodiment.

FIG. 4 is a front view of the rear view mirror assembly according to the first exemplary embodiment.

FIG. 5 is a rear view of the rear view mirror assembly according to the first exemplary embodiment.

FIG. 6 is a block diagram showing a configuration of the rear view mirror assembly according to the first exemplary embodiment.

FIG. 7 illustrates transitions of operating modes of the rear view mirror assembly according to the first exemplary embodiment.

FIG. 8 illustrates a first distance according to the first exemplary embodiment.

FIG. 9 is a flowchart of initialization of the rear view mirror assembly according to the first exemplary embodiment.

FIG. 10 is a flowchart of an automatic detecting operation and an automatic tilting operation performed after a mirror mode is set in the rear view mirror assembly according to the first exemplary embodiment.

FIG. 11 is a detailed flowchart of step S1700 in FIG. 10.

FIG. 12 is a detailed flowchart of step S1800 in FIG. 10.

FIG. 13 is a flowchart of a manual switching operation and the automatic tilting operation performed after the mirror mode is set in the rear view mirror assembly according to the first exemplary embodiment.

FIG. 14 is a flowchart of an operation of a camera of the rear view mirror assembly according to the first exemplary embodiment.

FIG. 15 is a flowchart of the automatic detecting operation and the automatic tilting operation performed after a dimming mode is set in the rear view mirror assembly according to the first exemplary embodiment.

FIG. 16 illustrates a configuration of a conventional rearview mirror having a built-in monitor.

FIG. 17 illustrates a configuration of a conventional electrochromic mirror.

FIG. 18 is a flowchart of an operation of a rear view mirror assembly according to a variation of the first exemplary embodiment.

FIG. 19 is a flowchart of another operation of the rear view mirror assembly according to the variation of the first exemplary embodiment.

FIG. 20 is a front view of a rear view mirror assembly according to a second exemplary embodiment.

FIG. 21 is a block diagram showing a configuration of the rear view mirror assembly according to the second exemplary embodiment.

FIG. 22 illustrates transitions of operating modes of the rear view mirror assembly according to the second exemplary embodiment.

FIG. 23 is a flowchart of an operation of the rear view mirror assembly according to the second exemplary embodiment.

FIG. 24 is a flowchart of another operation of the rear view mirror assembly according to the second exemplary embodiment.

FIG. 25 is a flowchart of a still other operation of the rear view mirror assembly according to the second exemplary embodiment.

### DESCRIPTION OF EMBODIMENTS

Prior to descriptions of exemplary embodiments of the present disclosure, problems of a conventional apparatus will be briefly described. Electrochromic device 18 disclosed in PTL 2 requires an expensive electrochromic reflective element, which leads to a problem of an increase in the entire manufacturing cost of the mirror. Moreover, if a liquid crystal display monitor or the like is included in addition to the electrochromic reflective element in order to display an image captured by a camera externally mounted on the vehicle, not only the manufacturing cost, but also the total weight of the mirror will increase.

Hereinafter, embodiments of the present disclosure will be described with reference to the drawings. Note that the same reference numbers throughout the drawings denote the same or corresponding parts.

### First Exemplary Embodiment

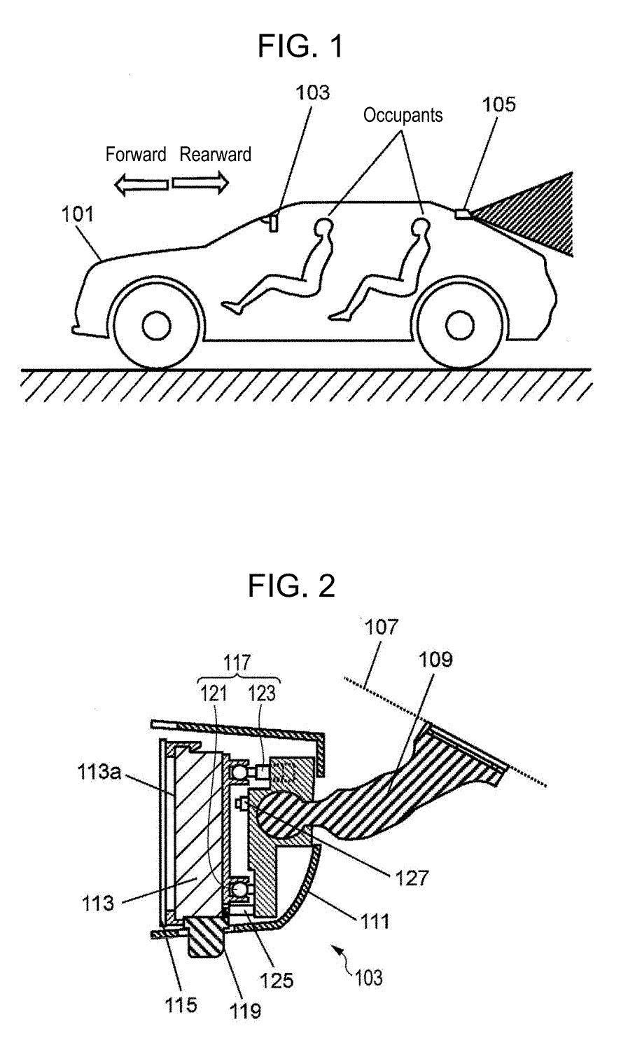

FIG. 1 illustrates vehicle 101 equipped with rear view mirror assembly 103 according to a first exemplary embodiment of the present disclosure. Rear view mirror assembly 103 is mounted on the windshield of vehicle 101, and also functions as a rearview mirror (optical mirror).

Camera 105 is mounted to vehicle 101 to capture a rearward image of vehicle 101. For example, camera 105 is mounted on a rear part of vehicle 101. Camera 105 transmits the captured image to rear view mirror assembly 103 as an image signal. Rear view mirror assembly 103 receives the image signal transmitted from camera 105, and displays the rearward image of vehicle 101 captured by camera 105. An occupant of vehicle 101 can check the situation rearward of vehicle 101 by visually recognizing the image displayed on rear view mirror assembly 103. In this way, rear view mirror assembly 103 provides the occupant of vehicle 101 with a rearward field of view of vehicle 101.

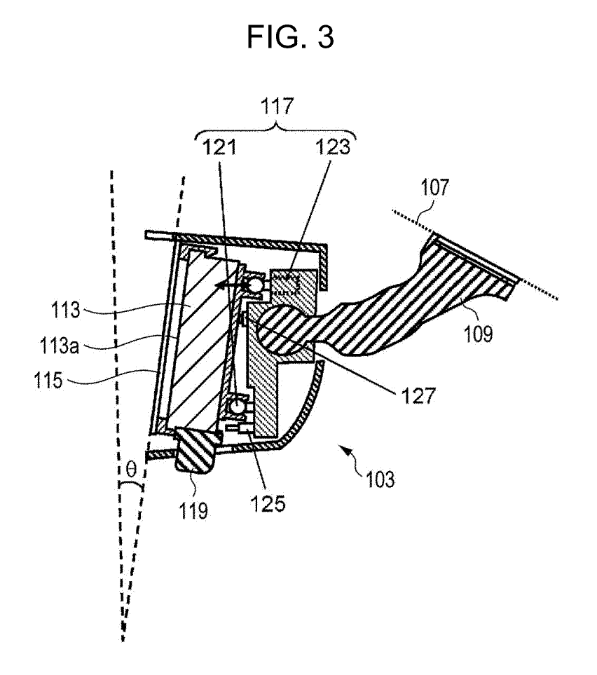

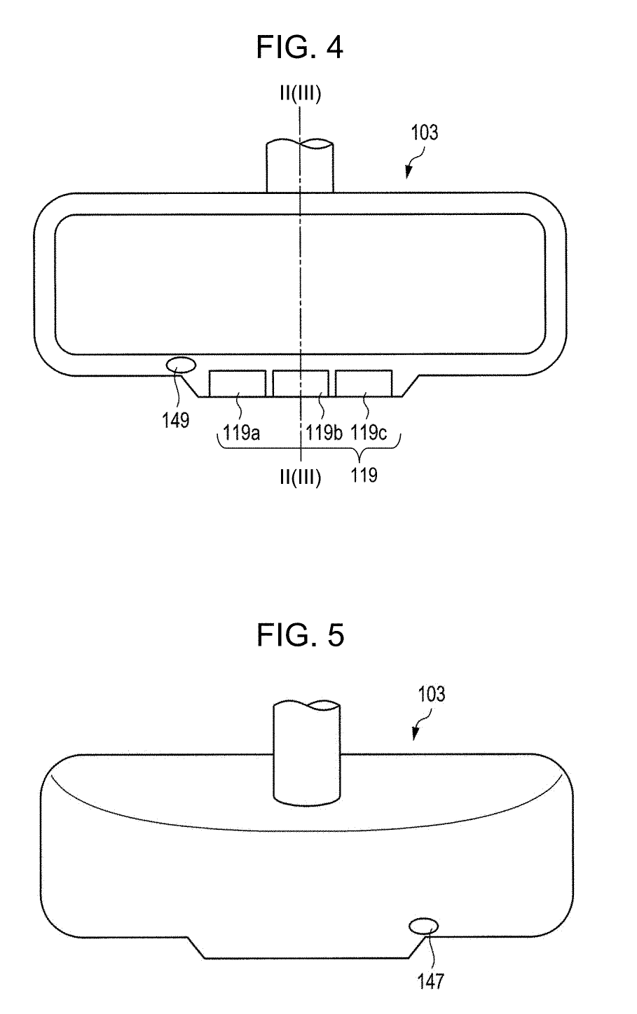

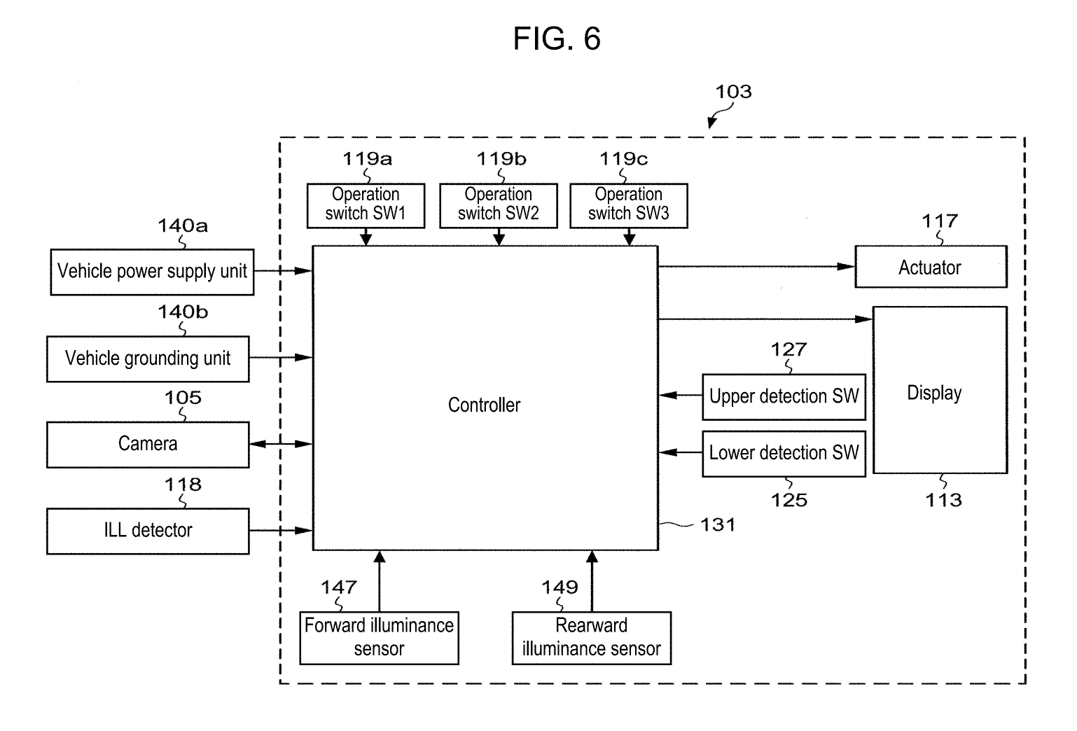

Next, details of rear view mirror assembly 103 according to the first exemplary embodiment will be described with reference to FIG. 2 to FIG. 6. FIG. 2 and FIG. 3 each are a cross-sectional view of rear view mirror assembly 103 according to the first exemplary embodiment. FIG. 4 is a front view of rear view mirror assembly 103, and FIG. 5 is a rear view of rear view mirror assembly 103. Note that FIG. 2 illustrates a cross section taken along broken line II-II in FIG. 4 when rear view mirror assembly 103 is in a mirror mode to be described later. FIG. 3 illustrates a cross section taken along broken line III-III in FIG. 4 when rear view mirror assembly 103 is in a camera image mode to be described later. FIG. 6 is a block diagram showing a configuration of rear view mirror assembly 103 according to the first exemplary embodiment.

As illustrated in FIG. 2 to FIG. 6, rear view mirror assembly 103 includes housing 111, display 113, mirror 115, actuator 117, operation unit 119, lower detection switch 125, upper detection switch 127, forward illuminance sensor 147, and rearward illuminance sensor 149. As illustrated in FIG. 2, rear view mirror assembly 103 is mounted on the interior surface side of windshield 107 of vehicle 101, via mounting arm 109.

Display 113 is disposed inside housing 111. Display 113 includes display screen 113a. Display 113 is, for example, a liquid crystal display (LCD) including a backlight. ON and off of display 113 can be switched. Display 113 displays an image on display screen 113a when display 113 is on. Display 113 does not display an image on display screen 113a when display 113 is off.

Mirror 115 is disposed over display screen 113a of display 113. Mirror 115 is a semitransparent mirror. When display 113 is on, the image displayed on display screen 113a passes through mirror 115, which allows the occupant to visually recognize the image. In contrast, when display 113 is off, mirror 115 serves as a reflective surface. Accordingly, the occupant can check rearward of vehicle 101 by viewing the image reflected in mirror 115, in the same manner as for conventional rearview mirrors.

In cases where the occupant is checking rearward with display unit 113 being on, even when something wrong abruptly turns off display 113, the occupant can continue to check rearward by using mirror 115. This means that mirror 115 has a fail-safe function.

In rear view mirror assembly 103 illustrated in FIG. 2, display 113 is off. In this state, the angle formed by the surface of mirror 115 and the vertical upward vector (hereinafter, referred to as the angle of mirror 115) is set at a first angle at which the occupant can check rearward of vehicle 101 through the rear windshield of vehicle 101 by visually recognizing mirror 115. Hereinafter, the operating mode of rear view mirror assembly 103 when the angle of mirror 115 is set at the first angle is referred to as a “mirror mode (first mode)”.

In contrast, in rear view mirror assembly 103 illustrated in FIG. 3, display 113 is on. In this state, the angle of mirror 115 is set such that display 113 is at antiglare angle θ which is greater than the first angle. Here, the antiglare angle refers to an angle at which intense light emitted from rearward of vehicle 101 (for example, from headlights of a following vehicle) is not reflected in mirror 115 when the occupant visually recognizes mirror 115. For example, the outward normal vector to the surface of mirror 115 is pointing more upward in FIG. 3 than in FIG. 2. In this state, when the occupant visually recognizes mirror 115, the ceiling of vehicle 101 is reflected in mirror 115, and thus, the intense light emitted from rearward of vehicle 101 is not reflected in mirror 115.

In the first exemplary embodiment, the angle of display screen 113a is also changed in conjunction with mirror 115. However, when display 113 is a display such as an LCD, which offers a wide viewing angle, changing the angle to some extent has no significant influence on the visual recognition, by the occupant, of the image that is displayed on display screen 113a. Hereinafter, the operating mode of rear view mirror assembly 103 in the state where the angle of mirror 115 is set at an antiglare angle is referred to as a “camera image mode”.

Actuator 117 adjusts the angle of mirror 115. Actuator 117 includes actuation supporting point 121 and rod 123. Tips of actuation supporting point 121 and rod 123 are pivotably fixed to a lower part and an upper part of display 113, respectively. For example, actuator 117 drives a motor (not illustrated) included in actuator 117 so that rod 123 connected to the motor is extended and contracted. Extension and contraction of rod 123 changes the angle of display 113 and the angle of mirror 115 disposed over display screen 113a.

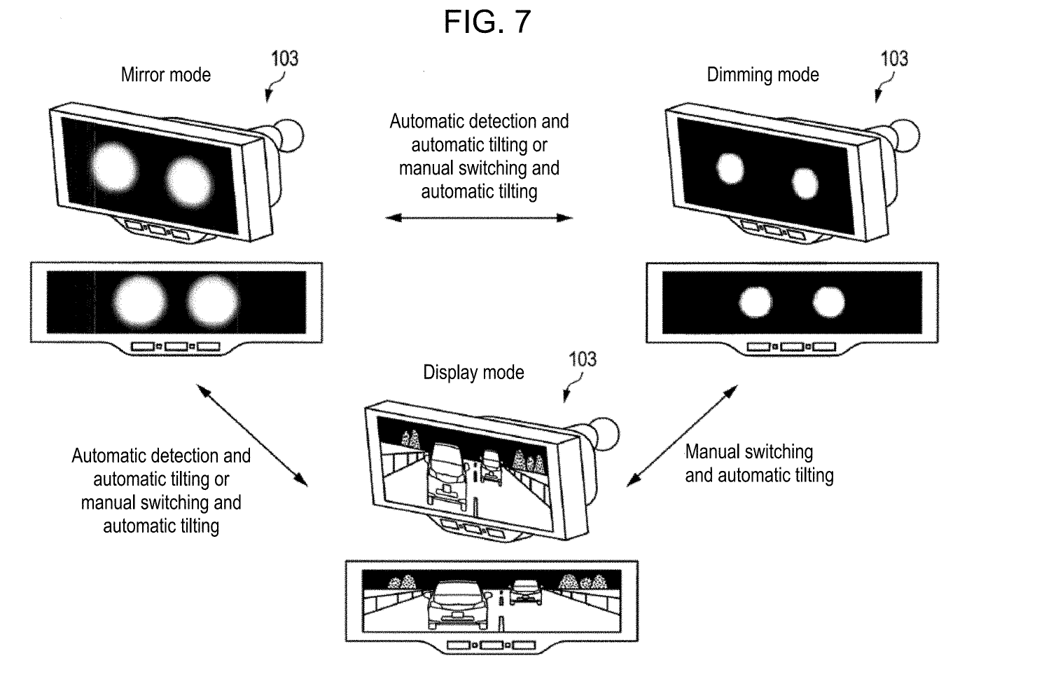

Operation unit 119 includes first switch 119a, second switch 119b, and third switch 119c. The occupant can turn on display 113 by pushing first switch 119a, when the operating mode of rear view mirror assembly 103 is a mirror mode. Moreover, the occupant can switch the operating mode of rear view mirror assembly 103 between a mirror mode, a display mode (second mode) and a dimming mode (third mode) to be described later with reference to FIG. 7, by operating second switch 119b and third switch 119c. Note that the camera image mode described above includes the display mode and the dimming mode.

Lower detection switch 125 and upper detection switch 127 are disposed inside housing 111. As illustrated in FIG. 2, lower detection switch 125 is disposed at a position at which lower detection switch 125 is turned on when being pushed by the rear side of display 113 in the mirror mode, and is turned off when not being pushed by the rear side of display 113 in the camera image mode. In contrast, as illustrated in FIG. 3, upper detection switch 127 is disposed at a position at which upper detection switch 127 is turned on when being pushed by the rear side of display 113 in the camera image mode, and is turned off when not being pushed by the rear side of display 113 in the mirror mode. Accordingly, it is possible to determine whether or not the angle of mirror 115 is set at the first angle, by monitoring on and off of lower detection switch 125. Moreover, it possible to determine whether or not the angle of mirror 115 is set at a predetermined antiglare angle, by monitoring on and off of upper detection switch 127.

Forward illuminance sensor 147 outputs a sensor signal indicating the illuminance of ambient light around vehicle 101 and rearward illuminance sensor 149 outputs a sensor signal indicating the illuminance of light emitted from rearward of vehicle 101. In the first exemplary embodiment, as illustrated in FIG. 4 and FIG. 5, forward illuminance sensor 147 is disposed on the rear surface of housing 111 of rear view mirror assembly 103 and rearward illuminance sensor 149 is disposed on the front surface of housing 111 of rear view mirror assembly 103. The positions of forward illuminance sensor 147 and rearward illuminance sensor 149 are not particularly limited as long as forward illuminance sensor 147 can output the sensor signal indicating the illuminance of ambient light around vehicle 101 and rearward illuminance sensor 149 can output the sensor signal indicating the illuminance of light emitted from rearward of vehicle 101. Forward illuminance sensor 147 and rearward illuminance sensor 149 may be disposed on an element of vehicle 101 other tha rear view mirror assembly 103. Moreover, camera 105 may also serve as a rearward illuminance sensor.

As illustrated in FIG. 6, controller 131 included in rear view mirror assembly 103 is connected to display 113, actuator 117, first switch 119a, second switch 119b, and third switch 119c of operation unit 119, lower detection switch 125, upper detection switch 127, forward illuminance sensor 147, and rearward illuminance sensor 149.

Controller 131 is disposed on a circuit board inside display 113 of rear view mirror assembly 103, for example. Controller 131 is an electric circuit configured with a large scale integration (LSI) circuit or the like. Note that the position of controller 131 is not necessarily required to be inside housing 111. Instead, controller 131 may be disposed, as a separate-body controller unit, inside vehicle 101. Moreover, controller 131 may be divided and disposed on a plurality of circuit boards in such a manner that, for example, a part of controller 131 is integrated inside housing 111 of rear view mirror assembly 103 while another part is integrated in a controller unit disposed outside housing 111.

Controller 131 causes display 113 to display an image input from camera 105. In the first exemplary embodiment, camera 105 has an iris adjusting function for adjusting the iris of camera 105 and an angle-of-view control function for controlling the angle of view of camera 105. Controller 131 generates an iris command signal which indicates the iris level and an angle-of-view command signal which indicates the angle of view, and outputs the generated signals to camera 105. Camera 105 then captures an image based on the input iris command signal and the angle-of-view command signal, and outputs the captured image to controller 131.

Controller 131 outputs, to actuator 117, a mirror driving signal for adjusting the angle of the mirror. Here, actuator 117 and mirror 115 are physically connected to each other. The angle of mirror 115 is changed by an operation of actuator 117. Actuator 117 adjusts the angle of mirror 115 based on the input mirror driving signal.

Controller 131 determines whether or not first switch 119a has been pushed, based on the input signal from first switch 119a. Subsequently, when controller 131 determines that first switch 119a has been pushed, controller 131 outputs, to display 113, a command signal for turning on display 113 or a signal for causing display 113 to display a menu screen.

Controller 131 determines whether or not second switch 119b has been pushed, based on the input signal from second switch 119b. Subsequently, when controller 131 determines that second switch 119b has been pushed, controller 131 switches the operating mode of rear view mirror assembly 103 between a mirror mode and a display mode to be described later with reference to FIG. 7, or sets on and off of an automatic detection mode to be described later with reference to FIG. 7.

Controller 131 determines whether or not third switch 119c has been pushed, based on the input signal from third switch 119c. Subsequently, when controller 131 determines that third switch 119c has been pushed, controller 131 switches the operating mode of rear view mirror assembly 103 between a mirror mode, a display mode and a dimming mode to be described later with reference to FIG. 7, or sets on and off of the automatic detection mode.

Controller 131 receives, from lower detection switch 125 and upper detection switch 127, signals indicating on or off of lower detection switch 125 and upper detection switch 127. Controller 131 then determines, based on the received signals, whether the angle of mirror 115 is set at the first angle, the antiglare angle, or an angle between the first angle and the antiglare angle.

When display 113 is off, controller 131 detects a sensor signal indicating the illuminance of ambient light from forward illuminance sensor 147, and determines whether the illuminance indicated by the sensor signal is greater than or equal to a threshold value for a predetermined period, or less than or equal to a threshold value for the predetermined period. Moreover, controller 131 detects, from rearward illuminance sensor 149, a sensor signal indicating the illuminance of light emitted from rearward of vehicle 101, and determines whether or not the illuminance indicated by the sensor signal is greater than or equal to a threshold value for a predetermined period, or less than or equal to a threshold value for the predetermined period.

Controller 131 is further connected to vehicle power supply unit 140a, vehicle grounding unit 140b, camera 105, and illumination-power-line (ILL) detector 118.

Controller 131 receives power supply from vehicle power supply unit 140a. The supplied power is used for driving the structural elements of rear view mirror assembly 103 such as the motor (not illustrated) in actuator 117. Moreover, controller 131 provides grounding to the structural elements of rear view mirror assembly 103 via vehicle grounding unit 140b. For example, vehicle power supply unit 140a is a power supply unit such as an accessary power supply (ACC) of vehicle 101 or ignition power supply (IGN), and vehicle grounding unit 140b is a grounding unit such as an earth line of an on-vehicle battery.

Controller 131 detects an ILL signal from ILL detector 118. Here, the ILL signal refers to a signal which indicates that headlights mounted in vehicle 101 are on. When the ILL signal indicates “on”, controller 131 determines that vehicle 101 is travelling in a dark environment, such as at nighttime or in a tunnel. The operating mode of controller 131 when controller 131 determines that vehicle 101 is travelling in a dark environment, such as at nighttime or in a tunnel, as described above is referred to as a “nighttime mode”. In contrast, when the ILL signal indicates “off”, controller 131 determines that vehicle 101 is not travelling in a dark environment, such as at nighttime or in a tunnel (this means that controller 131 determines that vehicle 101 is travelling in the daytime, for example). The operating mode of the controller in this case is referred to as a “daytime mode”.

In the first exemplary embodiment, controller 131 determines whether to operate in the nighttime mode, based on the ILL signal. In addition to the above, or instead of the above, for example, when the illuminance indicated by the sensor signal of forward illuminance sensor 147 is equal to or less than a third threshold value for a predetermined period, controller 131 determines to operate in the nighttime mode, and when the illuminance indicated by the sensor signal is greater than or equal to a fourth threshold value for a predetermined period, controller 131 determines to operate in the daytime mode. Here, by setting the third threshold value to be less than the fourth threshold value, hysteresis is provided between the nighttime mode and the daytime mode. This can prevent the operating modes of controller 131 from being switched frequently between the nighttime mode and the daytime mode. Note that the third threshold value and the fourth threshold value may be less than, for example, a first threshold value and a second threshold value to be described later. Alternatively, for example, when the first threshold value is greater than the second threshold value, the third threshold value may be greater than or equal to the second threshold value and less than or equal to the first threshold value, and the fourth threshold value may be less than the second threshold value. Further alternatively, for example, when the first threshold value is greater than the second threshold value, the third threshold value and the fourth threshold value may be greater than or equal to the second threshold value and less than or equal to the first threshold value.

FIG. 7 illustrates transitions of operating modes of rear view mirror assembly 103 according to the first exemplary embodiment. Rear view mirror assembly 103 has three operating modes which are a mirror mode, a dimming mode, and a display mode. Those operating modes can be switched.

The display mode refers to a camera image mode in which display 113 displays a display mode image (a first image). Here, the display mode image refers to a rearward image of vehicle 101 captured by camera 105. In the display mode, intense light coming from rearward of vehicle 101 is not reflected in the mirror.

In one example, the display mode image has a first angle of view. Here, the first angle of view can be arbitrarily set as long as camera 105 can capture an image. For example, the rearward image of vehicle 101, captured by camera 105 in which the first angle of view is adjusted to a sufficiently large angle of view and the iris is set to the widest iris, is displayed on display 113 as a display mode image. For example, as illustrated in FIG. 7, it is possible to visually recognize a rearward vehicle on an adjacent lane, rearward road surface, guardrails, and the like, in addition to a following vehicle even during the nighttime. In this way, in the display mode, the occupant can visually recognize rearward of vehicle 101 in a sufficiently wide range, and a clear rearward view of vehicle 101 can be ensured.

The dimming mode refers to a camera image mode in which display 113 displays a dimming mode image (a second image). Here, when an image of the same object is captured in the dimming mode under the same capturing conditions as the display mode, the dimming mode image is displayed darker than the display mode image. For example, when the image of the same object is captured under the same capturing conditions, the object having a first luminance in the display mode image has a second luminance less than the first luminance in the dimming mode image. In other words, the dimming mode image refers to a rearward image of vehicle 101 displayed darker than the display mode image. In one example, the luminance of the display mode image varies within a first range, and the luminance of the dimming mode image varies within a second range which is less than the lower limit of the first range. Moreover, the first range and the second range may partially overlap. In other words, the upper limit of the second range may be included in the first range and the lower limit of the second range may be less than the lower limit of the first range. In one example, the dimming mode image has a second angle of view which is different from the first angle of view. The second angle of view refers to an angle of view at which how the vehicle located rearward from the surface of mirror 115 by a first distance is seen by the occupant is the same as the mirror mode. In the dimming mode, intense light coming from rearward of vehicle 101 is not reflected in the mirror.

In the display mode, the angle of mirror 115 is set such that display 113 is at a second angle greater than the first angle. In the dimming mode, the angle of mirror 115 is set at a third angle greater than the first angle. Here, both the second angle and the third angle are antiglare angles, and may be equal to each other or different from each other. For ease of explanation, the following description is given assuming that the second angle and the third angle are equal to each other. However, even when the second angle and the third angle are different from each other, a person skilled in the art would be able to easily modify the following description for application.

When camera 105 is mounted on the rear part of vehicle 101, the rearward image of vehicle 101 captured by camera 105 is an image seen from the rear part of vehicle 101 which is the mounting position of camera 105. In contrast, the image reflected in mirror 115 in the mirror mode is an image seen from a position plane-symmetrical to the viewpoint position of the occupant across the surface of mirror 115. As described above, the viewpoint position of the reflected image in the mirror mode is different from the viewpoint position of the rearward image of vehicle 101 in the camera image mode. Hence, how rearward of vehicle 101 is seen in the mirror mode is also different from that in the camera image mode.

Hence, in the dimming mode image, the angle of view is adjusted to the second angle of view such that the vehicle located rearward from the surface of mirror 115 by the first distance is seen by the occupant in the same way as in the mirror mode. In other words, the second angle of view is adjusted to be the same as the angle of view of mirror 115 when the occupant views mirror 115. In this way, in the dimming mode, the occupant can view the vehicle located rearward from the surface of mirror 115 by the first distance without suffering from the feeling of strangeness.

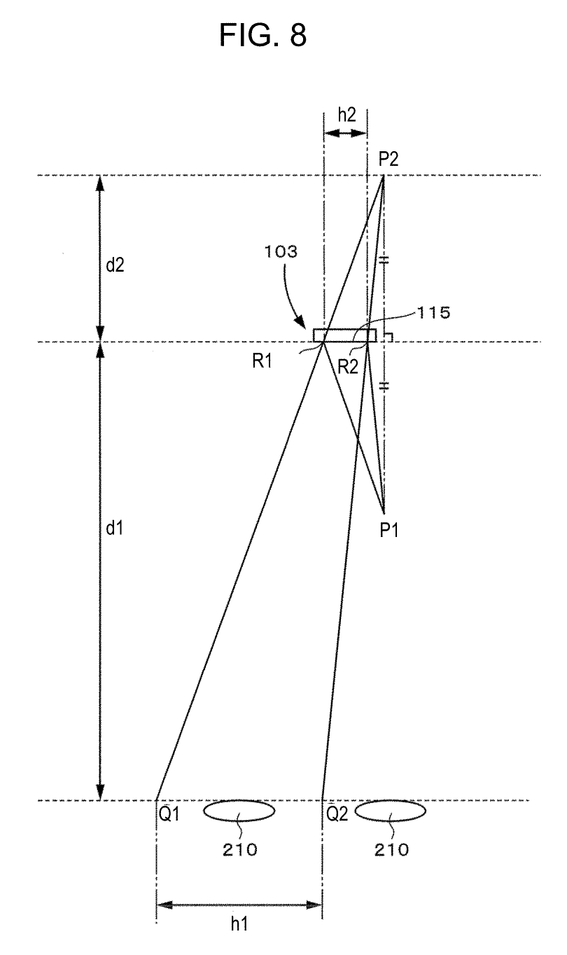

FIG. 8 illustrates the first distance according to the first exemplary embodiment. In one example, the second angle of view satisfies a relation of h1: h2=(d1+d2):d2 where h1(m) is the distance between points Q1 and Q2 which are located rearward from (the extended surface of) the surface of mirror 115 by first distance d1 (m), and h2 (m) is the distance between positions R1 and R2 at which points Q1 and Q2 are respectively displayed on a dimming mode image displayed on display 113. First distance d1 (m) represents the distance between the surface of mirror 115 of rear view mirror assembly 103 and headlight 210 of a following vehicle, for example. Moreover, for example, d2 (m) represents the distance between the surface of mirror 115 and position P1 within the vehicle corresponding to the viewpoint position of the occupant of vehicle 101. Here, an average viewpoint position of the occupant sitting in the driver seat may be obtained in advance, and the obtained position is determined to be position P1 within the vehicle. Position R1 (R2) is the intersection between the surface of mirror 115 and a straight line connecting point Q1 (Q2) and mirrored image point P2 of position P1 in the vehicle relative to the surface of mirror 115.

The first distance ranges, for example, from 5 m to 20 m. The first distance can be set in various ways. For example, a menu item for the occupant to set the first distance may be disposed on the menu screen displayed on display 113 of rear view mirror assembly 103 so that the distance set by the occupant via the menu item is set as the first distance. Moreover, controller 131 may set the first distance in accordance with the speed of vehicle 101 input from a measuring means which measures the vehicle speed, such as a speed meter of vehicle 101.

For example, while vehicle 101 is traveling on a highway, the inter-vehicular distance between vehicle 101 and a following vehicle is generally relatively large. In contrast, while vehicle 101 is traveling in an urban area, the inter-vehicular distance between vehicle 101 and a following vehicle is generally relatively small. In this way, the inter-vehicular distance between vehicle 101 and a following vehicle generally varies according to the speed of vehicle 101. Accordingly, for example, controller 131 may store a map for obtaining an assumed inter-vehicular distance between vehicle 101 and a following vehicle from the speed of vehicle 101, and set the first distance based on the assumed inter-vehicular distance obtained from the map.

Moreover, when vehicle 101 includes a measuring means (millimeter wave radar, infrared radar, or the like) which measures the inter-vehicular distance between vehicle 101 and a following vehicle, controller 131 may set, as the first distance, the distance obtained by adding, for example, the distance between the rear part of vehicle 101 and rear view mirror assembly 103 to the inter-vehicular distance measured by the measuring means.

For example, the rearward image of vehicle 101, captured by camera 105 in which the angle of view is adjusted to the second angle of view and the iris is adjusted according to the value output from rearward illuminance sensor 149, is displayed on display 113 as a dimming mode image. Accordingly, in the dimming mode, a clear rearward view of vehicle 101 can be ensured while reducing the feeling of strangeness and glare suffered by the occupant. Accordingly, it is possible to provide the antiglare function substantially the same as the antiglare function provided by a conventional electrochromic mirror, in the dimming mode of rear view mirror assembly 103.

Now, a description is given again with reference to FIG. 7. When controller 131 operates in the nighttime mode and the automatic detection mode is on, mirror 115 automatically tilts according to the illuminance of light incident from rearward, so that the mirror mode and the dimming mode are automatically switched. Accordingly, it is possible to ensure a clear rearward view of vehicle 101 as well as constantly reducing glare suffered by the occupant regardless of the illuminance of light incident from rearward, when vehicle 101 is traveling in a dark ambient environment, such as at nighttime or in a tunnel. Moreover, the angle of view of the dimming mode image is adjusted to the second angle of view such that the vehicle located rearward from the surface of mirror 115 by the first distance is seen in the same way between the mirror mode and the dimming mode. Accordingly, it is possible to reduce the feeling of strangeness suffered by the occupant when the mirror mode and the dimming mode are switched automatically. Note that in one example, it may be that the dimming mode can be set to be off by the occupant. When the occupant sets the automatic detection mode to be on and sets the dimming mode to be off, mirror 115 automatically tilts according to the illuminance of light incident from rearward, and the mirror mode and the display mode are automatically switched.

Moreover, the occupant can manually switch the operating mode of rear view mirror assembly 103 between the mirror mode, the dimming mode, and the display mode by operating operation unit 119.

When rear view mirror assembly 103 is in the dimming mode or the display mode, the occupant can course display 113 to display a menu screen (not illustrated) by pushing first switch 119a, for example. Subsequently, the occupant selects a menu item for setting on and off of the automatic detection mode within the menu screen by pushing, for example, second switch 119b and third switch 119c, so that the occupant can set on and off of the automatic detection mode.

Moreover, the occupant can switch the operating mode of rear view mirror assembly 103 between the mirror mode and the display mode by pushing second switch 119b, for example. Moreover, the occupant can switch the operating mode of rear view mirror assembly 103 between the mirror mode and the dimming mode by short pressing third switch 119c, for example. Moreover, the occupant can switch the operating mode of rear view mirror assembly 103 between the dimming mode and the display mode by long pressing third switch 119c, for example.

When the angle of mirror 115 is different from the first angle at the time of switching of the operating mode of rear view mirror assembly 103 to the mirror mode, for example, mirror 115 automatically tilts so that the angle of mirror 115 becomes the first angle. Moreover, when the angle of mirror 115 is different from the second angle at the time of switching of the operating mode of rear view mirror assembly 103 to the dimming mode or the display mode, mirror 115 automatically tilts so that the angle of mirror 115 becomes the second angle, for example.

The display mode of rear view mirror assembly 103 is convenient when the occupant wants to visually recognize rearward of vehicle 101 in a wider range. However, since how the rearward of vehicle 101 is seen in the display mode is different from those in the mirror mode and by the conventional rearview mirror, some of the occupants who are used to the conventional rearview mirror may be unused to the use of the display mode which does not exist in the conventional rearview mirror. Even if the occupant is unused to the use of the display mode, the occupant can get used to the dimming mode relatively quickly because how the rearward of vehicle 101 is seen in the dimming mode is relatively similar to those in the mirror mode and by the conventional rearview mirror. Rear view mirror assembly 103 has an appeal for such an occupant, too.

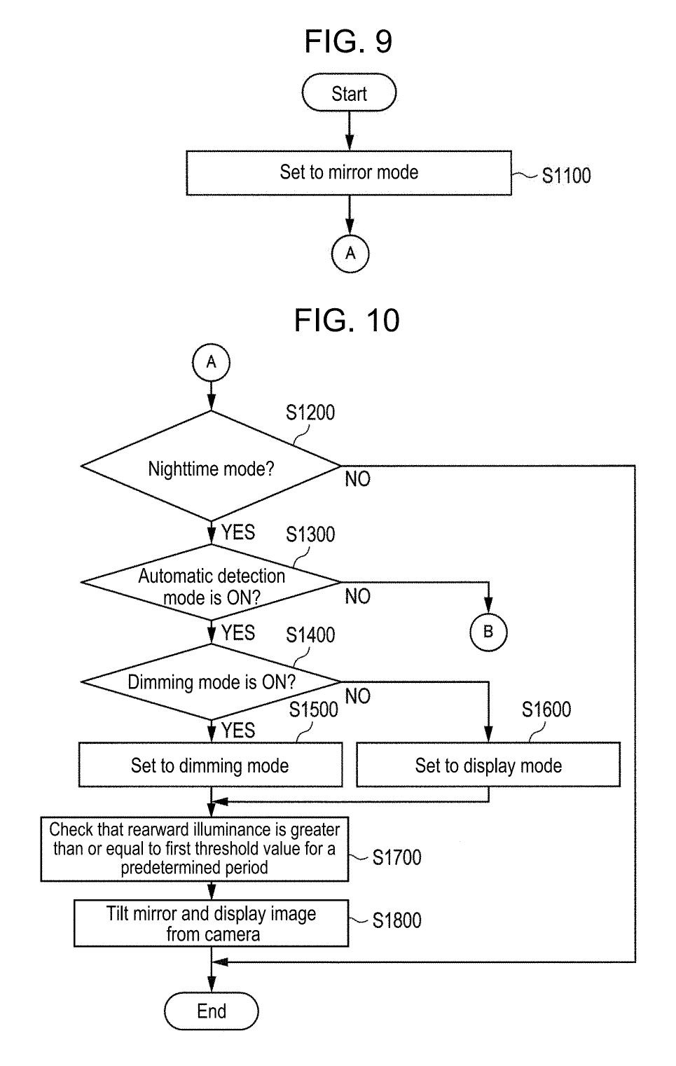

FIG. 9 is a flowchart of initialization of rear view mirror assembly 103 according to the first exemplary embodiment. First, controller 131 sets the operating mode of rear view mirror assembly 103 to a mirror mode (step S1100). Next, the processing proceeds to node “A” illustrated in FIG. 10.

FIG. 10 is a flowchart of the automatic detection operation and the automatic tilting operation performed after the mirror mode is set in rear view mirror assembly 103 according to the first exemplary embodiment. The flow starts from node “A”. First, controller 131 determines whether or not controller 131 is operating in the nighttime mode (step S1200). When controller 131 determines that controller 131 is not operating in the nighttime mode (step S1200: No), controller 131 ends the processing in the flow while maintaining the operating mode of rear view mirror assembly 103 as the mirror mode.

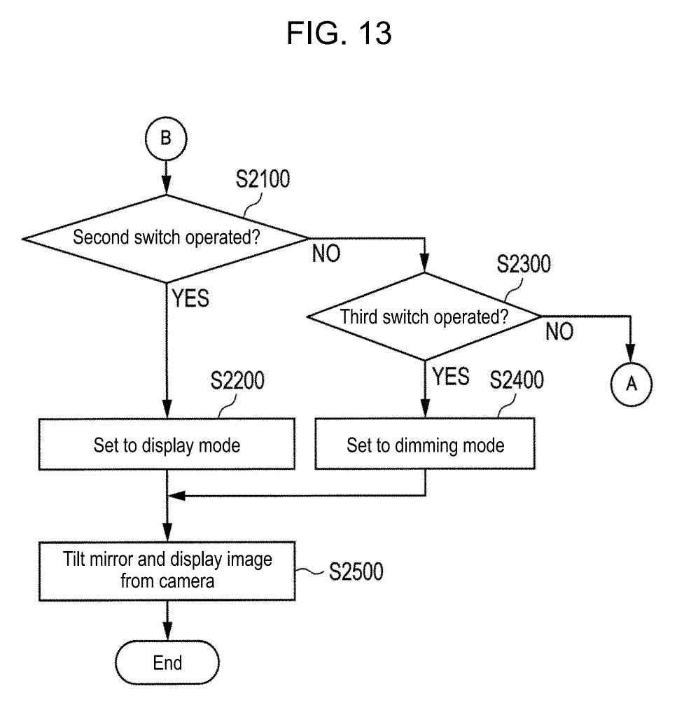

When controller 131 determines that controller 131 is operating in the nighttime mode (step S1200: YES), controller 131 then determines whether or not the automatic detection mode is on (step S1300). When controller 131 determines that the automatic detection mode is not on (step S1300: NO), the processing proceeds to node “B” illustrated in FIG. 13.

In contrast, when controller 131 determines that the automatic detection mode is on (step S1300: YES), controller 131 determines whether or not the dimming mode is on (Step S1400). When controller 131 determines that the dimming mode is on (step S1400: YES), controller 131 sets the operating mode of rear view mirror assembly 103 to the dimming mode (Step S1500). In contrast, when controller 131 determines that the dimming mode is not on (step S1400: NO), controller 131 sets the operating mode of rear view mirror assembly 103 to the display mode (step S1600). Note that when the present specification describes that the operating mode of the rear view mirror assembly is set to the dimming mode or the operating mode of the rear view mirror assembly is set to the display mode, it means that the details of the command signal (to be described later) to camera 105 or the details of the image processing performed by rear view mirror assembly 103 are set for the dimming mode or the display mode. At this stage, the mirror has not yet been tilted, and the image has not been displayed on display 113, either.

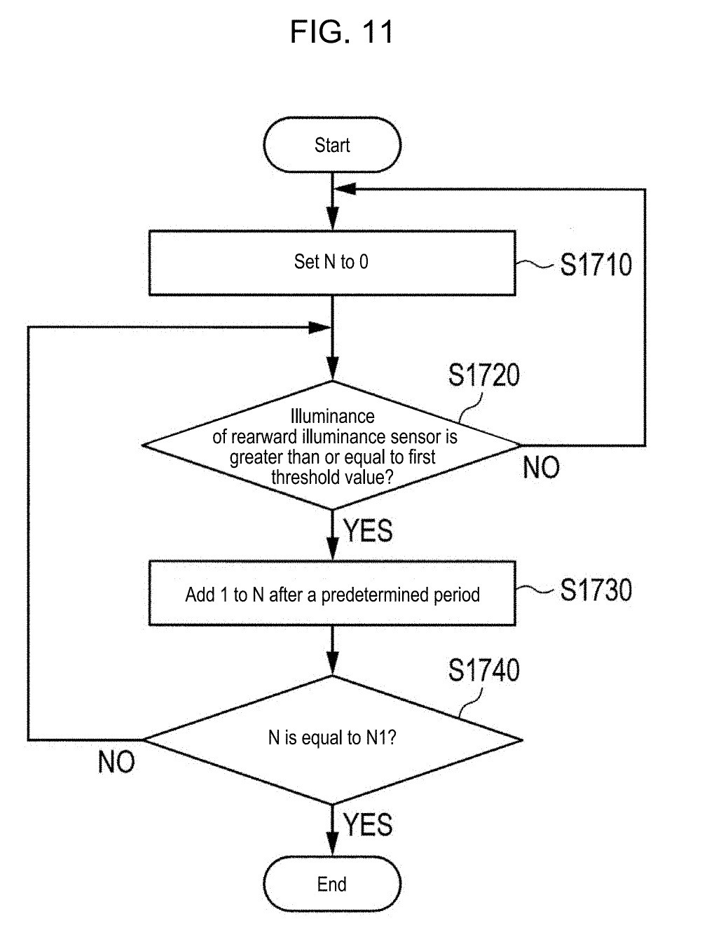

Next, controller 131 checks that the rearward illuminance is greater than or equal to the first threshold value for a predetermined period (step S1700). The details of the processing in step S1700 will be described later with reference to FIG. 11.

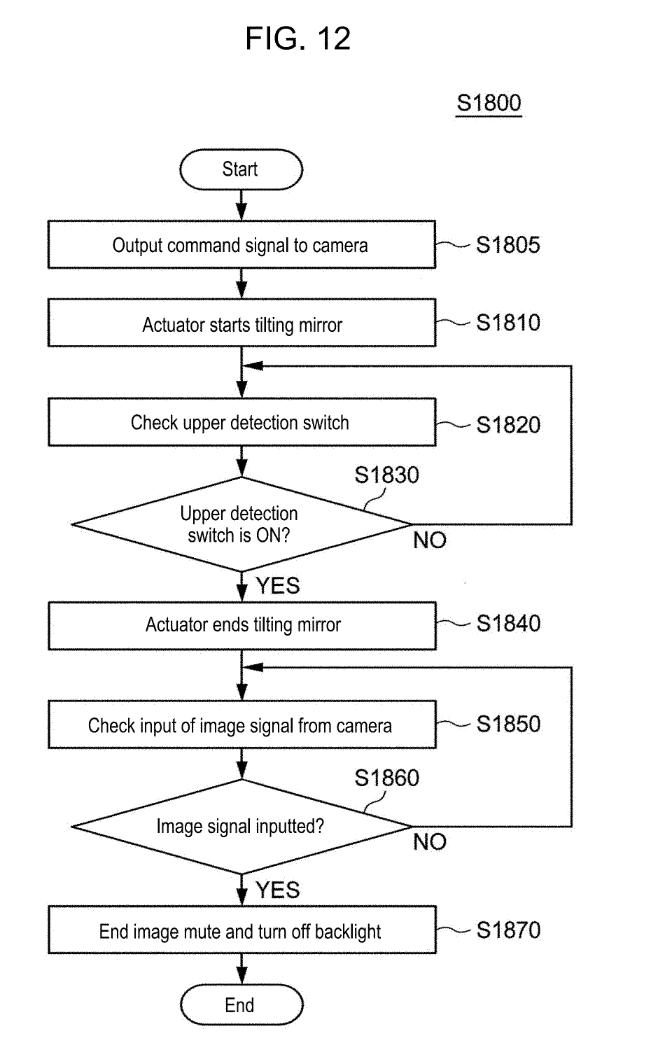

Next, controller 131 causes mirror 115 to tilt and causes an image from the camera to be displayed (step S1800). The details of the processing in step S1800 will be described later with reference to FIG. 12.

FIG. 11 is a detailed flowchart of step S1700 in FIG. 10. In step S1700, first, controller 131 initializes the value of variable N stored in controller 131 to 0 (step S1710). Next, controller 131 determines whether or not the output of rearward illuminance sensor 149 is greater than or equal to the first threshold value (step S1720). When the output of rearward illuminance sensor 149 is not greater than or equal to the first threshold value (step S1720: NO), the processing returns to step S1710.

When the output of rearward illuminance sensor 149 is greater than or equal to the first threshold value (step S1720: YES), controller 131 adds 1 to variable N after a waiting for a predetermined period (step S1730). Controller 131 then determines whether or not variable N is equal to constant number N1 (step S1740). When N is not equal to N1 (step S1740: NO), the processing returns to step S1720. When variable N is equal to constant number N1 (step S1740: YES), controller 131 ends the processing in step S1700. Here, the predetermined period and constant number N1 are arbitrarily set according to a preferable time interval from when the output of rearward illuminance sensor 149 is detected as being greater than or equal to the first threshold value till the operating mode of rear view mirror assembly 103 is actually switched.

FIG. 12 is a detailed flowchart of step S1800 in FIG. 10. First, controller 131 outputs a command signal to camera 105 (step S1805). Here, the command signal includes a capturing start command signal which commands start of the capturing. In the first exemplary embodiment, the command signal further includes an iris command signal for commanding the iris of camera 105 and an angle-of-view command signal for commanding the angle of view of camera 105, according to the operating mode (display mode or dimming mode) of rear view mirror assembly 103.

Next, actuator 117 driven by controller 131 starts tilting mirror 115 (step S1810). Controller 131 then checks upper detection switch 127 (step S1820) to determine whether or not upper detection switch 127 is on (step S1830). When upper detection switch 127 is not on (step S1830: NO), the processing returns to step S1820.

When upper detection switch 127 is on (step S1830: YES), the angle of mirror 115 has become the second angle, and thus, actuator 117 ends tilting mirror 115 (step S1840). Next, controller 131 checks the input of the image signal from camera 105 (step S1850) to determine whether or not the image signal has been input (step S1860). Here, the input image signal is a signal of a display mode image when the operating mode of rear view mirror assembly 103 is the display mode, and is a signal of a dimming mode image when the operating mode of rear view mirror assembly 103 is the dimming mode.

When controller 131 determines that the image signal has not been input (step S1860: NO), the processing returns to step S1850. When controller 131 determines that the image signal has been input (step S1860: YES), controller 131 turns on display 113, ends image muting by outputting the image signal to display 113, and turns on the backlight of display 113 (step S1870). Controller 131 then ends the processing in the flow.

FIG. 13 is a flowchart of the manual switching and the automatic tilting operation performed after the mirror mode is set in rear view mirror assembly 103 according to the first exemplary embodiment. First, controller 131 determines whether or not second switch 119b has been operated (step S2100). Here, second switch 119b having been operated means that second switch 119b has been pushed.

When controller 131 determines that second switch 119b has been operated (step S2100: YES), controller 131 sets the operating mode of camera 105 to the display mode (step S2200). Controller 131 then causes mirror 115 to tilt and causes the display mode image from the camera to be displayed in the same procedure as step S1800 (step S2500), and ends the processing in the flow.

In contrast, when controller 131 determines that second switch 119b has not been operated (step S2100: NO), controller 131 determines whether or not third switch 119c has been operated. Here, third switch 119c having been operated means that third switch 119c has been short pressed.

When controller 131 determines that third switch 119c has been operated (step S2300: YES), controller 131 sets the operating mode of camera 105 to the dimming mode (step S2400). Controller 131 then causes mirror 115 to tilt and causes display 113 to display the dimming mode image from camera 105 (step S2500) in the same procedure as step S1800, and ends the processing in the flow. In contrast, when controller 131 determines that third switch 119c has not been operated (step S2300: NO), the proceeding proceeds to node “A” in FIG. 10.

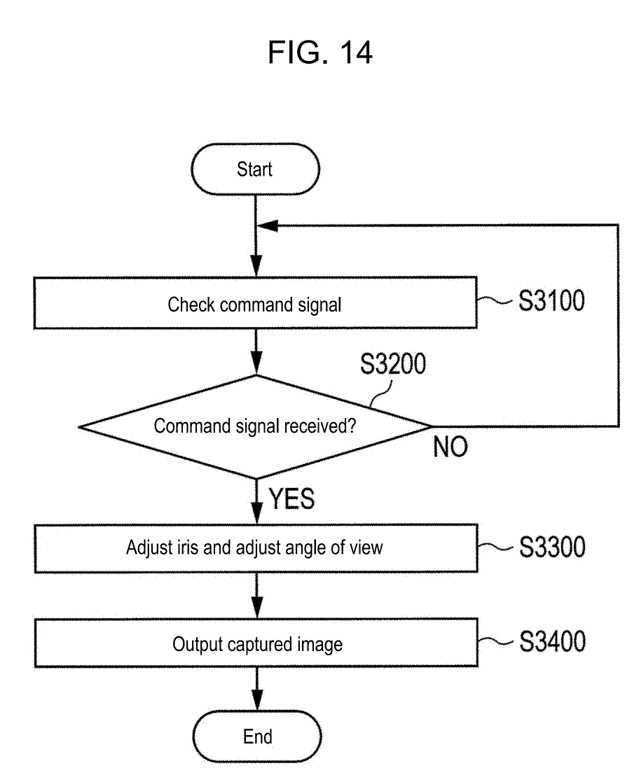

FIG. 14 is a flowchart of an operation of camera 105 of rear view mirror assembly 103 according to the first exemplary embodiment. First, camera 105 checks the command signal including the image capturing command signal output from controller 131 (step S3100) to determine whether or not camera 105 has received the command signal (step S3200). In the first exemplary embodiment, the command signal includes an iris command signal and an angle-of-view setting signal which are generated by controller 131 and output to camera 105, according to the operating mode of rear view mirror assembly 103. When camera 105 determines that camera 105 has not received the command signal (step S3200: NO), the processing returns to step S3100.

When camera 105 determines that camera 105 has received the command signal (step S3200: YES), and when the command signal includes the iris command signal and the angle-of-view setting signal, camera 105 adjusts the iris and the angle of view based on the signals (step S3300). Camera 105 then outputs the captured image (step S3400), and ends the processing in the flow.

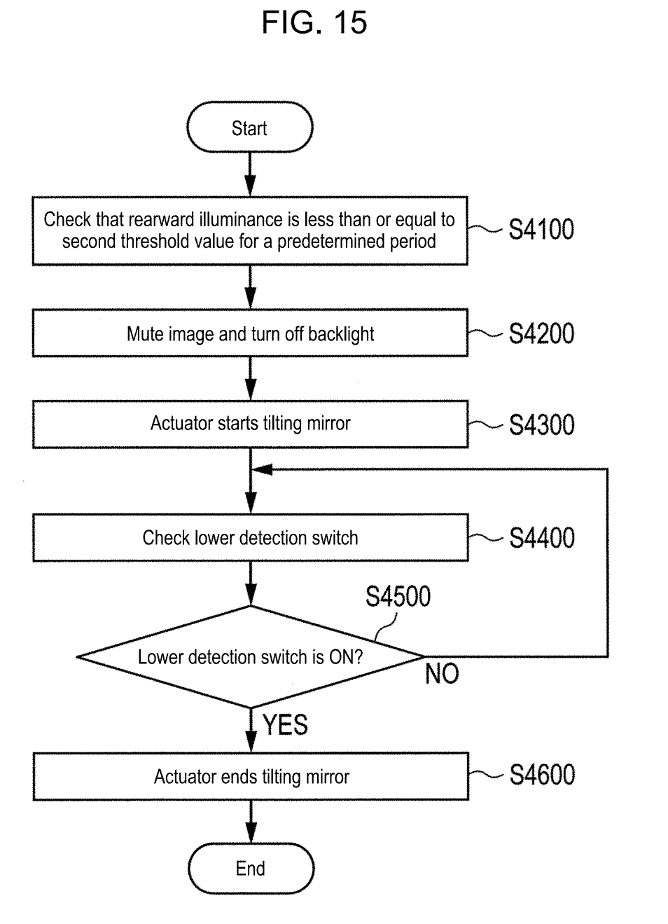

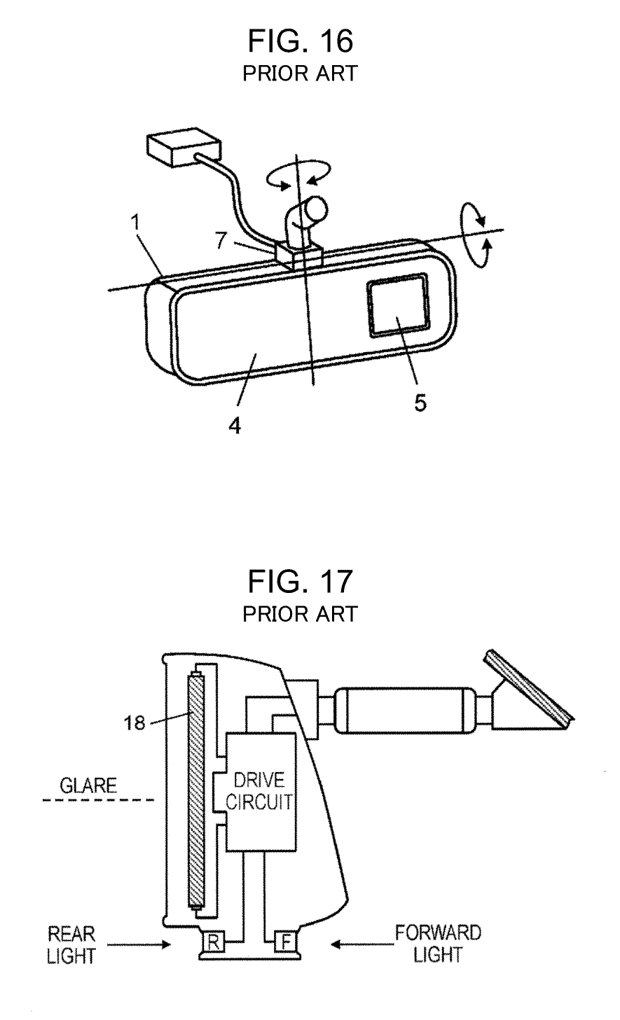

FIG. 15 is a flowchart of the automatic detection operation and the automatic tilting operation performed when rear view mirror assembly 103 according to the first exemplary embodiment returns to the mirror mode from the state where display 113 displays an image (that is, when returning from the dimming mode to the mirror mode, or when returning from the display mode to the mirror mode).

First, controller 131 checks that the rearward illuminance is less than or equal to the second threshold value for a predetermined period (step S4100). Step S4100 is such that in the detailed flowchart of step S1700 illustrated in FIG. 11, determination in step S1720 of whether or not the output is greater than or equal to the first threshold value is replaced with the determination of whether or not the output is less than or equal to the second threshold value, and constant number N1 in step S1740 is replaced with constant number N2.

Here, the second threshold value may be less than the first threshold value. Accordingly, when the automatic detection mode is on, hysteresis is provided between the operating modes of rear view mirror assembly 103. This can prevent the operating modes from being switched frequently.

Next, controller 131 mutes the image by turning off display 113, and turns off the backlight of display 113 (step S4200). Controller 131 also stops the output of the image signal to display 113.

Next, actuator 117 driven by controller 131 starts tilting the mirror (step S4300). The direction of the tilting in step S4300 is opposite to the direction of tilting in step S1810 in FIG. 12.

Controller 131 then checks lower detection switch 125 (step S4400) to determine whether or not lower detection switch 125 is on (step S4500). When controller 131 determines that lower detection switch 125 is not on (step S4500: NO), the processing returns to step S4400.

When lower detection switch 125 is on (step S4500: YES), the angle of mirror 115 has become the first angle, and thus, actuator 117 ends tilting mirror 115 (step S4600), and ends the processing in the flow.

### Variation of First Exemplary Embodiment

Next, a variation of the first exemplary embodiment will be described. In the first exemplary embodiment described above, the switching between the display mode (second mode) and the dimming mode (third mode) can be performed only manually. In contrast, the present variation is different from the first exemplary embodiment in that the display mode and the dimming mode can also be switched automatically.

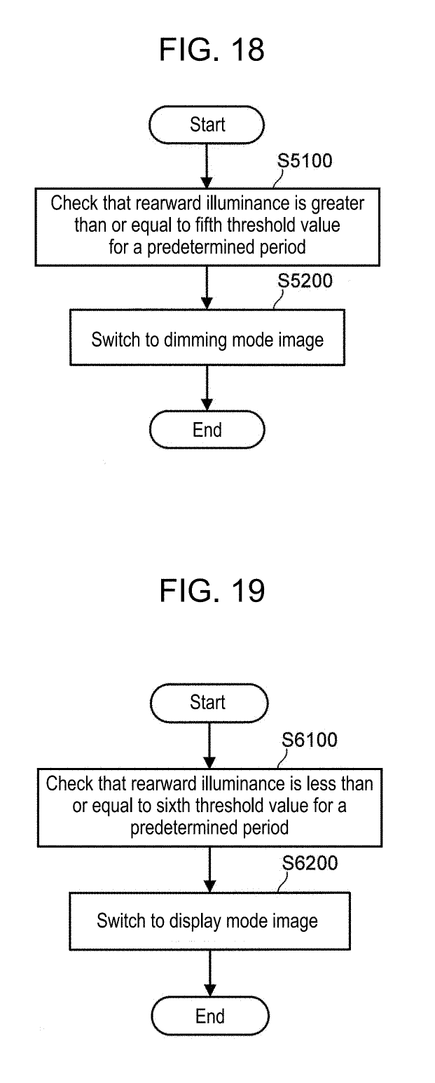

FIG. 18 and FIG. 19 each are a flowchart of an operation of rear view mirror assembly 103 according to the variation of the first exemplary embodiment. Note that the front view, the rear view, the cross-sectional views, and the functional block diagram in the present variation are the same as those in the first exemplary embodiment, and thus, the descriptions thereof will be omitted. Moreover, the transitions between the mirror mode and the dimming mode, and the transitions between the mirror mode and the display mode in the present variation are also the same as those in the first exemplary embodiment, and thus, the descriptions thereof will be omitted.

FIG. 18 is a flowchart of the automatic detection operation performed when the operating mode of rear view mirror assembly 103 transitions from the display mode to the dimming mode. When the operating mode of rear view mirror assembly 103 is the display mode, and the display mode image is being displayed on display 113, controller 131 checks that the rearward illuminance is greater than or equal to a fifth threshold value for a predetermined period (step S5100). In step S5100, the threshold value, which is the first threshold value used for the determination in step S1720 in the detailed flowchart of step S1700 in FIG. 11 is replaced with the fifth threshold value.

Next, controller 131 switches the image displayed on display 113 from the display mode image to the dimming mode image, and ends the processing in the flow (step S5200). Note that in a case where the angle of mirror 115 in the display mode is different from that in the dimming mode, tilting of the mirror is also performed in conjunction with the switching of the image.

In contrast, FIG. 19 is a flowchart of the automatic detection operation performed when the operating mode of rear view mirror assembly 103 transitions from the dimming mode to the display mode. When the operating mode of rear view mirror assembly 103 is the dimming mode, and the dimming mode image is being displayed on display 113, controller 131 checks that the rearward illuminance is less than or equal to a sixth threshold value for a predetermined period (step S6100). In step S6100, the determination of whether or not the output is greater than or equal to the first threshold value in step S1720 in the detailed flowchart of step S1700 in FIG. 11 is replaced with the determination of whether or not the output is less than or equal to the sixth threshold value.

Next, controller 131 switches the image displayed on display 113 from the dimming mode image to the display mode image, and ends the processing in the flow (step S6200). Note that when the angle of mirror 115 in the display mode is different from that in the dimming mode, tilting of mirror 115 is also performed in conjunction with the switching of the image.

Here, the fifth threshold value may be greater than the sixth threshold value. Accordingly, when the automatic detection mode is on, hysteresis is provided between the operating modes of rear view mirror assembly 103. This can prevent the operating modes from being switched frequently. Here, for example, the fifth threshold value and the sixth threshold value may be greater than the first threshold value and the second threshold value. Alternatively, for example, when the first threshold value is greater than the second threshold value, the fifth threshold value may be greater than the first threshold value, and the sixth threshold value may be greater than or equal to the second threshold value and less than or equal to the first threshold value. Further alternatively, for example, when the first threshold value is greater than the second threshold value, the fifth threshold value and the sixth threshold value may be greater than or equal to the second threshold value and less than or equal to the first threshold value.

As described above, in the rear view mirror assembly according to the present variation, the display mode and the dimming mode are automatically switched according to the illuminance of light incident from rearward.

The rear view mirror assembly according to the present variation can be applied to, for example, a case as described below. It is assumed that the operating mode of rear view mirror assembly 103 is the mirror mode, and the occupant sets the automatic detection to be on and the dimming mode to be off. In this state, when light is emitted from the headlights of a following vehicle located rearward of vehicle 101, the operating mode is switched to the display mode in accordance with the flowchart illustrated in FIG. 10. Next, when the illuminance of the headlights of the following vehicle is relatively low (for example, in the case of low beam), the operating mode of rear view mirror assembly 103 is maintained as the display mode (it corresponds to a case where the rearward illuminance is less than the fifth threshold value). In contrast, when the illuminance of the headlight of the following vehicle is relatively high (for example, in the case of high beam), the operating mode of rear view mirror assembly 103 is switched from the display mode to the dimming mode (it corresponds to a case where the rearward illuminance is greater than or equal to the fifth threshold value for a predetermined period).

In this manner, in the rear view mirror assembly according to the variation of the first exemplary embodiment, even if the occupant sets the dimming mode to be off, the operating mode is automatically switched from the mirror mode to the dimming mode when the rearward illuminance is greater than a predetermined value. Accordingly, even when the illuminance of the headlights of the following vehicle is high, it is possible to reduce glare suffered by the driver.

### Second Exemplary Embodiment

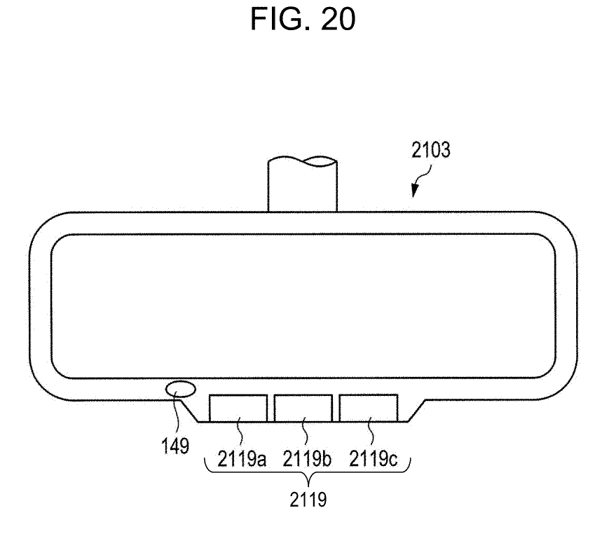

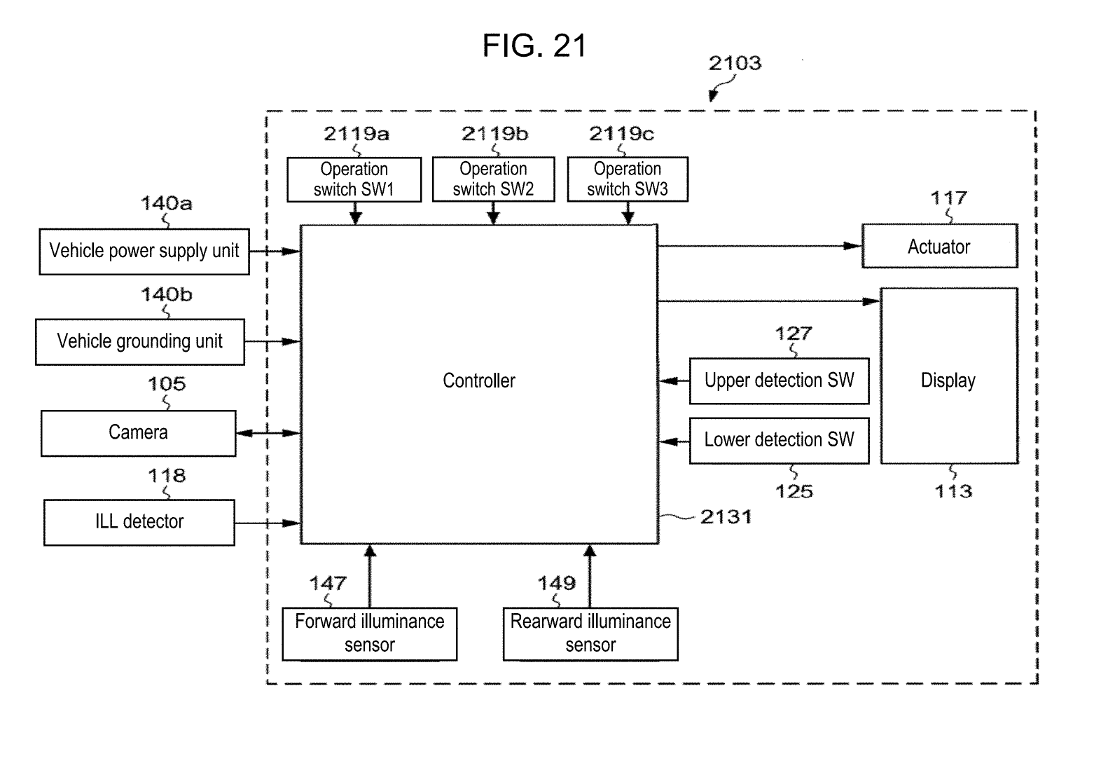

Next, a second exemplary embodiment will be described. FIG. 20 is a front view of rear view mirror assembly 2103 according to the second exemplary embodiment. FIG. 21 is a functional block diagram showing a configuration of rear view mirror assembly 2103. Rear view mirror assembly 2103 according to the second exemplary embodiment is different from rear view mirror assembly 103 according to the first exemplary embodiment in the functions assigned to first switch 2119a to third switch 2119c, and the operation of controller 2131. The other configuration of rear view mirror assembly 2103 is the same as rear view mirror assembly 103 according to the first exemplary embodiment, and thus, the description thereof will be omitted.

Operation unit 2119 includes first switch 2119a, second switch 2119b, and third switch 2119c. First switch 2119a is a switch for switching the automatic detection mode between on and off. The occupant can select whether the transitions of the operating modes of rear view mirror assembly 2103 to be performed by automatically or manually, by pushing first switch 2119a. Moreover, second switch 2119b is a display switch. The occupant can manually switch display 113 between on and off, by pushing second switch 2119b. Moreover, third switch 2119c is a dimming mode switch. The occupant can switch the operating mode of rear view mirror assembly 2103 to the dimming mode, by pushing third switch 2119c.

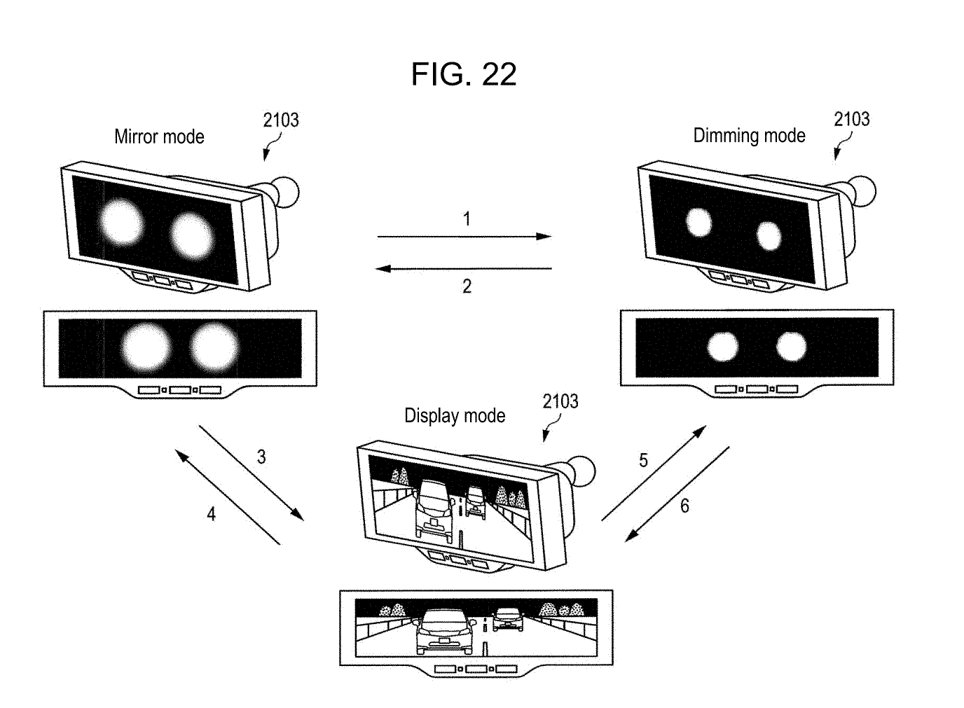

FIG. 22 illustrates transitions of the operating modes of rear view mirror assembly 2103 according to the second exemplary embodiment. Rear view mirror assembly 2103 has three operating modes which are a mirror mode, a dimming mode, and a display mode. Those operating modes can be switched. Table 1 below indicates conditions 1 to 6 for transitions of respective operating modes in FIG. 22.

TABLE 1

| Transition | |
|---|---|
| Number | Condition for Transition |
| 1 | When dimming mode button is on, |
| | (automatic) nighttime mode is on and |
| | rearward illuminance ≥ threshold value |
| | (manual) operate display button to be on |
| 2 | (automatic *1) rearward illuminance ≤ threshold value |
| | (manual) operate display button to be off |
| 3 | When dimming mode button is off, |
| | (automatic) nighttime mode is on |
| | (manual) operate display button to be on |
| 4 | (automatic) nighttime mode is off |
| | (manual) operate display button to be off |
| 5 | (automatic) rearward illuminance ≥ threshold value |
| | (manual) operate dimming mode button to be on |
| 6 | (automatic *2) rearward illuminance ≤ threshold value |
| | (manual) operate dimming mode button to be off |

(*1) only after automatically transitioned from mirror mode
(*2) only after automatically transitioned from display mode

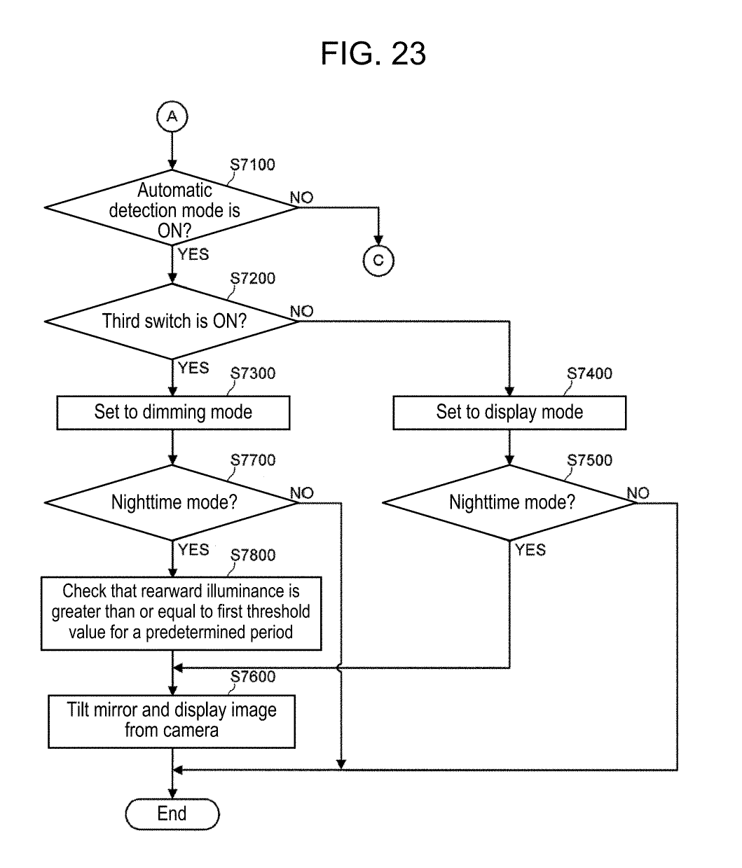

Hereinafter, the details of transitions of respective operating modes will be described with reference to FIG. 23 to FIG. 25. The flowchart of the initialization of rear view mirror assembly 2103 is the same as FIG. 9 described in the first exemplary embodiment.

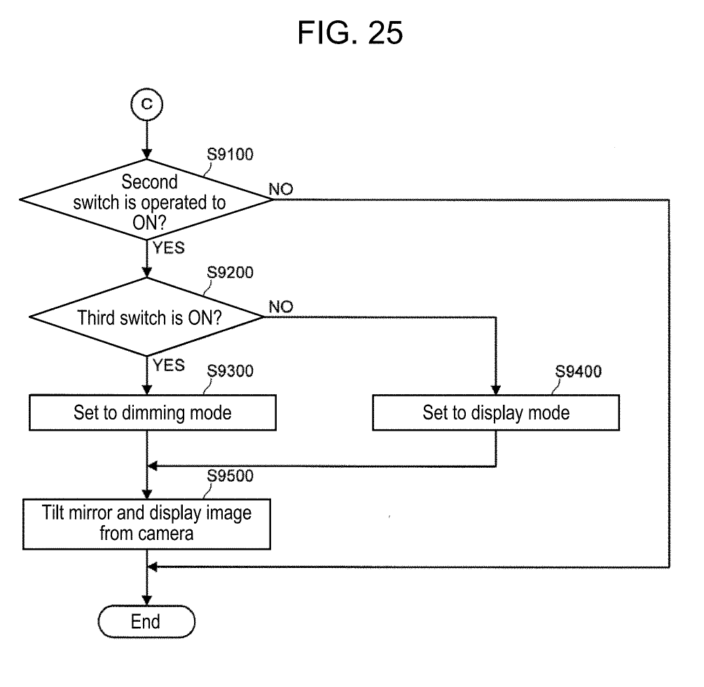

First, with reference to the flowchart in FIG. 23, the automatic detection operation and the automatic tilting operation performed when the operating mode of rear view mirror assembly 2103 transitions from the mirror mode to the display mode or to the dimming mode (that is, transition 1 or 3 in FIG. 22) will be described. The flow starts from node “A”. First, controller 2131 determines whether or not the automatic detection mode is on (step S7100). When controller 2131 determines that the automatic detection mode is not on (step S7100: NO), the processing proceeds to node “C” illustrated in FIG. 25. The operations subsequent to node “C” are manual switching operations, and thus, the description will be given later with reference to FIG. 25. In contrast, when controller 2131 determines that the automatic detection mode is on (step S7100: YES), controller 2131 determines whether or not third switch 2119c is on (step S7200).

When controller 2131 determines that third switch 2119c is on (step S7200: YES), controller 2131 sets the operating mode of rear view mirror assembly 2103 to the dimming mode (step S7300). In contrast, when controller 2131 determines that third switch 2119c is not on (step S7200: NO), controller 2131 sets the operating mode of rear view mirror assembly 2103 to the display mode (step S7400).

After step S7400, controller 2131 determines whether or not controller 2131 is operating in the nighttime mode (step S7500). When controller 2131 determines that controller 2131 is not operating in the nighttime mode (that is, the vehicle is not in a dark environment) (step S7500: NO), controller 2131 ends the processing in the flow while maintaining the operating mode of rear view mirror assembly 2103 as the display mode.

When controller 2131 determines that controller 2131 is operating in the nighttime mode (that is, the vehicle is in a dark environment) (step S7500: YES), controller 2131 causes mirror 115 to tilt, and causes an image from the camera to be displayed (step S7600). The processing details of step S7600 are the same as FIG. 12 described in the first exemplary embodiment.

After step S7300, controller 2131 determines whether or not controller 2131 is operating in the nighttime mode (step S7700). When controller 2131 determines that controller 2131 is not operating in the nighttime mode (that is, the vehicle is not in a dark environment) (Step S7700: NO), controller 2131 ends the processing in the flow while maintaining the operating mode of rear view mirror assembly 2103 as the dimming mode.

In contrast, when controller 2131 determines that controller 2131 is operating in the nighttime mode (step S7700: YES), controller 2131 checks that the rearward illuminance is greater than or equal to the first threshold value for a predetermined period (step S7800). The processing details of step S7800 are the same as FIG. 11 described in the first exemplary embodiment.

Next, controller 2131 causes mirror 115 to tilt, and causes an image from the camera to be displayed (step S7600).

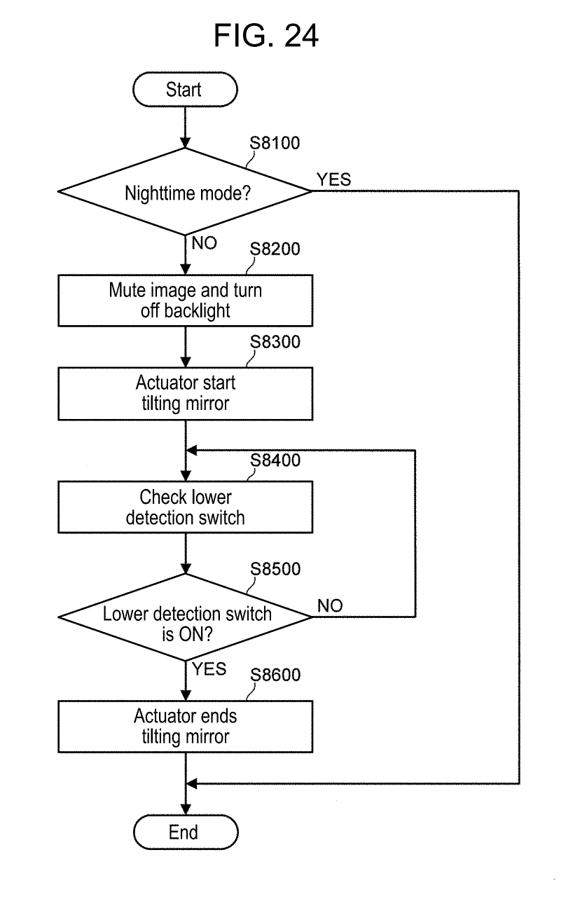

Next, with reference to the flowchart in FIG. 24, the automatic detection operation and the automatic tilting operation performed when the operating mode of rear view mirror assembly 2103 transitions from the display mode to the mirror mode (that is, transition 4 in FIG. 22) will be described.

First, controller 2131 determines whether or not controller 2131 is operating in the nighttime mode (step S8100). When controller 2131 determines that controller 2131 is operating in the nighttime mode (that is, the vehicle is in a dark environment) (step S8100: YES), controller 2131 ends the processing in the flow while maintaining the operating mode of rear view mirror assembly 2103 as the display mode.

When controller 2131 determines that controller 2131 is not operating in the nighttime mode (that is, the vehicle is not in a dark environment) (step S8100: NO), controller 2131 mutes the image by turning off display 113, and turns off the backlight of display 113 (step S8200). Controller 2131 also stops the output of the image signal to display 113.

Actuator 117 driven by controller 2131 then starts tilting the mirror (step S8300).

Next, controller 2131 checks lower detection switch 125 (step S8400) to determine whether or not lower detection switch 125 is on (step S8500). When controller 2131 determines that lower detection switch 125 is not on (step S8500: NO), the processing returns to step S8400.

When lower detection switch 125 is on (step S8500: YES), the angle of mirror 115 has become the first angle, and thus, actuator 117 ends tilting mirror 115 (step S8600), and ends the processing in the flow.

Note that the automatic detection operation and the automatic tilting operation performed when the operating mode of rear view mirror assembly 2103 transitions from the dimming mode to the mirror mode (that is, transition 2 in FIG. 22) are the same as FIG. 15 described in the first exemplary embodiment. Here, the operating mode of rear view mirror assembly 2103 transitions from the dimming mode to the mirror mode by the automatic detection only immediately after the transition of the operating mode of rear view mirror assembly 2103 from the mirror mode to the dimming mode by the automatic detection.

Moreover, the automatic detection operation and the automatic tilting operation performed when the operating mode of rear view mirror assembly 2103 transitions between the display mode and the dimming mode (that is, transition 5 or 6 in FIG. 22) are the same as FIG. 18 and FIG. 19 described in the first exemplary embodiment. Note that the operating mode of rear view mirror assembly 2103 transitions from the dimming mode to the display mode by the automatic detection only immediately after the transition of the operating mode of rear view mirror assembly 2103 from the display mode to the dimming mode by the automatic detection.

Next, manual switching will be described. Manual switching and the automatic tilting operations performed when the operating mode of rear view mirror assembly 2103 transitions from the mirror mode to the display mode or to the dimming mode (that is, transition 1 or 3 in FIG. 22) will be described with reference to the flowchart in FIG. 25. The flow starts from node “C”.

First, controller 2131 determines whether or not second switch 2119b is on (step S9100).

When controller 2131 determines that second switch 2119b is not on (step S9100: NO), controller 2131 ends the processing in the flow while maintaining the operating mode of rear view mirror assembly 2103 as the mirror mode. In contrast, when controller 2131 determines that second switch 2119b is on (step S9100: YES), controller 2131 determines whether or not third switch 2119c is on (step S9200).

When controller 2131 determines that third switch 2119c is not on (step S9200: NO), controller 2131 sets the operating mode of rear view mirror assembly 2103 to the display mode (step S9400). In contrast, when controller 2131 determines that third switch 2119c is on (step S9200: YES), controller 2131 sets the operating mode of rear view mirror assembly 2103 to the dimming mode (step S9300).

Next, controller 2131 causes mirror 115 to tilt and causes an image from the camera to be displayed (step S9500), and ends the processing in the flow. The processing details of step S9500 are the same as FIG. 12 described in the first exemplary embodiment.

Note that when the operating mode of rear view mirror assembly 2103 is manually switched from the dimming mode or the display mode to the mirror mode, second switch 2119b is operated to be off (transition 2 or 4 in FIG. 22).

When the operating mode of rear view mirror assembly 2103 is manually switched between the dimming mode and the display mode, third switch 2119c is operated to switch between on and off (transition 5 or 6 in FIG. 22).

### Other Exemplary Embodiments

It has been described in the above embodiments that actuator 117 is a mechanism for simultaneously changing the angle of mirror 115 and the angle of display 113. Instead of this, actuator 117 may change only the angle of mirror 115.

In the above described embodiments, the rearward image of the vehicle, which is captured by camera 105 in which the angle of view and the iris have been adjusted, is displayed on display 113 as the dimming mode image. Instead of this, the angle of view and the luminance of the rearward image of the vehicle captured by camera 105 may be adjusted through image processing by using an image processing circuit connected to the controller. This eliminates the need for the iris adjusting function and the angle-of-view adjusting function of camera 105. Moreover, instead of the adjustment of the iris, the luminance of the image displayed on display screen 113a may be reduced by reducing the intensity of the backlight of display 113.

In the above described embodiments, the controller detects sensor signals from forward illuminance sensor 147 and rearward illuminance sensor 149. Instead of this, the controller may detect a sensor signal from another sensor included in the rear view mirror assembly or from a sensor included in an element of vehicle 101 other than the rear view mirror assembly.

In the above described embodiments, the controller determines whether the angle of mirror 115 is the first angle, the second angle, or other by using lower detection switch 125 and upper detection switch 127. Instead of this, controller 131 may count the number of steps of the motor (not illustrated) of actuator 117, and stops the motor after the motor rotates by a predetermined number of steps. This can eliminate lower detection switch 125 and upper detection switch 127.

### INDUSTRIAL APPLICABILITY

A rear view mirror assembly according to the present disclosure is suitable for use instead of a rearview mirror used by the driver of a vehicle to check rearward of the vehicle.

### REFERENCE MARKS IN THE DRAWINGS

101 vehicle
103, 2103 rear view mirror assembly
105 camera
107 windshield glass
109 mounting arm
111 housing
113 display
113a display screen
115 mirror
117 actuator
118 ILL detector
119, 2119 operation unit
119a, 2119a first switch
119b, 2119b second switch
119c, 2119c third switch
121 actuation supporting point
123 rod
125 lower detection switch
127 upper detection switch
131, 2131 controller
140a vehicle power supply unit
140b vehicle grounding unit
147 forward illuminance sensor
149 rearward illuminance sensor
210 headlight of a following vehicle

1. A rear view mirror assembly comprising:
a display including a display screen which displays a rearward image of a vehicle, the image being captured by a camera mounted to the vehicle;
a semitransparent mirror disposed over the display screen;
an actuator which tilts the semitransparent mirror;
a controller which drives the actuator; and
a first light sensor which outputs a signal indicating an illuminance of light emitted from rearward of the vehicle,
wherein an operating mode of the rear view mirror assembly is switchable between a first mode, a second mode, and a third mode, the first mode being a mode in which the rear view mirror assembly is used as an optical mirror, the second mode being a mode in which a first image captured by the camera is displayed on the display screen, the third mode being a mode in which a second image captured by the camera is displayed on the display screen, the second image being displayed darker than the first image,
the actuator:
sets the semitransparent mirror in the first mode such that a vertical upward vector and a surface of the semitransparent mirror form a first angle;
sets the semitransparent mirror in the second mode such that the vertical upward vector and the surface of the semitransparent mirror form a second angle which is greater than the first angle; and
sets the semitransparent mirror in the third mode such that the vertical upward vector and the surface of the semitransparent mirror form a third angle which is greater than the first angle, and
the controller switches the operating mode of the rear view mirror assembly between the first mode and the third mode based on the signal output from the first light sensor.

2. The rear view mirror assembly according to claim 1,
wherein the first image has a first angle of view in the second mode,
the second image has a second angle of view in the third mode, the second angle of view being different from the first angle of view, and
the second angle of view is an angle of view of the semitransparent mirror when a driver of the vehicle visually recognizes the semitransparent mirror.

3. The rear view mirror assembly according to claim 2,
wherein the second angle of view satisfies a following relation:
h1:h2=(d1+d2):d2
where d1 is a given first distance, d2 is a distance between the surface of the semitransparent mirror and a position inside of the vehicle corresponding to a position of a viewpoint of the driver, h1 is a distance between two points which are located rearward from the surface of the semitransparent mirror by the given first distance, and h2 is a distance between positions of the two points in the second image displayed on the display screen.

4. The rear view mirror assembly according to claim 3,
wherein the controller receives information indicating a speed of the vehicle from a means which measures the speed of the vehicle and which is included in the vehicle, and sets the given first distance based on the speed of the vehicle.

5. The rear view mirror assembly according to claim 3,
wherein the controller receives information indicating an inter-vehicular distance from a means which measures the inter-vehicular distance and which is included in the vehicle, and sets the given first distance based on the inter-vehicular distance, the inter-vehicular distance being a distance between the vehicle and a following vehicle.

6. The rear view mirror assembly according to claim 2,
wherein the controller adjusts an iris of the camera and an angle of view of the camera, and causes the display screen to display, as the second image, an image which is captured by the camera in which the iris and the angle of view have been adjusted.

7. The rear view mirror assembly according to claim 6,
wherein the controller adjusts the iris of the camera based on the illuminance indicated by the signal output from the first light sensor.

8. The rear view mirror assembly according to claim 1,
wherein the controller switches the operating mode of the rear view mirror assembly to the third mode, when the rear view mirror assembly is in the first mode and the illuminance indicated by the signal output from the first light sensor is greater than or equal to a first threshold value for a predetermined period, and
the controller switches the operating mode of the rear view mirror assembly to the first mode, when the rear view mirror assembly is in the third mode and the illuminance indicated by the signal output from the first light sensor is less than or equal to a second threshold value for the predetermined period.

9. The rear view mirror assembly according to claim 8,
wherein the first threshold value is greater than the second threshold value.

10. The rear view mirror assembly according to claim 1,
wherein the controller switches the operating mode of the rear view mirror assembly to the second mode, when the rear view mirror assembly is in the first mode and the controller determines that the vehicle is in a dark environment.

11. The rear view mirror assembly according to claim 10,
wherein the controller detects an illumination-power-line (ILL) signal which indicates whether or not a headlight of the vehicle is on,
the controller determines that the vehicle is in the dark environment when the ILL signal is on, and
the controller determines that the vehicle is not in the dark environment when the ILL signal is off.

12. The rear view mirror assembly according to claim 10, further comprising
a second light sensor which outputs a signal indicating an illuminance of ambient light around the vehicle,
wherein the controller determines that the vehicle is in the dark environment, when the illuminance indicated by the signal output from the second light sensor is less than or equal to a third threshold value for a predetermined period, and
the controller determines that the vehicle is not in the dark environment when the illuminance indicated by the signal output from the second light sensor is equal to or greater than a fourth threshold value for the predetermined period.

13. The rear view mirror assembly according to claim 12,
wherein the third threshold value is less than the fourth threshold value.

14. The rear view mirror assembly according to claim 1,
wherein the controller switches the operating mode of the rear view mirror assembly to the third mode, when the rear view mirror assembly is in the second mode and the illuminance indicated by the signal output from the first light sensor is greater than or equal to a fifth threshold value for a predetermined period, and
the controller switches the operating mode of the rear view mirror assembly to the second mode, when the rear view mirror assembly is in the third mode and the illuminance indicated by the signal output from the first light sensor is less than or equal to a sixth threshold value for the predetermined period.

15. The rear view mirror assembly according to claim 14,
wherein the fifth threshold value is greater than the sixth threshold value.

16. The rear view mirror assembly according to claim 1,
wherein a luminance of the first image varies within a first range, and a luminance of the second image varies within a second range, and
a lower limit of the first range is greater than an upper limit of the second range.

17. The rear view mirror assembly according to claim 1,
wherein a luminance of the first image varies within a first range, and a luminance of the second image varies within a second range, and
an upper limit of the second range is included in the first range, and a lower limit of the second range is less than a lower limit of the first range.
